(19) United States
(12) Patent Application Publication
(10) Pub. No.: US 2003/0137428 A1
(43) Pub. Date: Jul. 24, 2003

(54) Solid state traffic light apparatus having suspended particle

(76) Inventor: Michael C. Hutchison, Plano, TX (US)

Correspondence Address: Jackson Walker, L.L.P., Suite 600, 2435 North Central Expressway, Richardson, TX, 75080, US

(21) Appl. No.: 10/338,925

(22) Filed: Jan. 8, 2003

Related U.S. Application Data
(60) Provisional application No. 60/346,658, filed on Jan. 8, 2002.

(51) Int. Cl. G08B 5/22

(52) U.S. Cl. 340/815.45; 340/907

(57) ABSTRACT

A solid state traffic control apparatus (10) having LED lights (12) including a suspended particle (52) for controlling both the color and shape of the illuminated light therefrom. The suspended particle (52), such as an LCD, operates as a light filter to generate green or yellow light, as well as to generate green and yellow arrows (60). Only two lights (12) are required, one generating red light, and the other generating all other colors including yellow, green, and colored arrows to accommodate color blind drivers. The light apparatus is also adapted for use as a pedestrian head (20) capable of generating different colored symbols such as a pedestrian (62), a hand (64), a count down timer (66), and the combination thereof. A diffuser (46) is disposed over the LED array (42) to provide a homogenous light to the suspended particle (52) which modulates the light to control shape and permit light of a certain color to transmit therethrough.

### CROSS REFERENCE TO RELATED APPLICATIONS

This application claims Priority of Provisional Application Serial No. 60/346,658, filed Jan. 8, 2002 entitled Solid State Traffic Light Apparatus Having Suspended Particle.

### CROSS REFERENCE TO RELATED APPLICATION

This application is related to commonly assigned U.S. Pat. No. 6,323,781 entitled “ELECTRONICALLY STEERABLE LIGHT OUTPUT VIEWING ANGLES FOR TRAFFIC SIGNALS”, the teachings of which are incorporated herein by reference.

### FIELD OF THE INVENTION

The present invention is generally related to traffic signal lights, and more particularly to traffic signal lights adapted to generate different colored lights and arrows for controlling both pedestrian and automobile traffic.

### BACKGROUND OF THE INVENTION

Conventional traffic control signals typically include multiple separate lights, one light for generating each of the three standard colors of red, yellow and green. Traditional incandescent lights are typically used and provided with an associated filter for generating the colored light. Separate masked lights are often used to generate green, yellow and red arrows for controlling turning traffic. Conventional incandescent lights tend to have the disadvantage of generating a light beam having a greater intensity at the center portion thereof than the outer portions of the light beam. While incandescent lights are relatively inexpensive by themselves, requiring numerous lights at each intersection, and the associated maintenance and replacement thereof, along with the exceptionally high energy consumption thereof, leads to a rather high maintenance, power hungry, and expensive traffic control system.

Solid state light sources including arrays of light emitting diodes (LEDs) are now starting to be implemented in traffic control systems. These solid state light sources have the advantages of reduced power consumption and increased operating life, thus reducing the amount of maintenance required. However, conventional solid state light sources may have non-uniform (non-homogenous) beam intensities due to optics, inconsistent LED outputs, or when one or more of the LEDs of the array has failed.

Even when using solid state light sources, typical traffic control systems implement multiple LED based lights, typically one light for each of the three basic colors of green, yellow and red, as well as separate LEDs for generating turn arrows. The turn arrows are typically formed by discreet LEDs positioned in the shape of an arrow, each LED generating a predetermined set color. Thus, even conventional LED traffic control systems incorporate many light units.

There is desired an improved solid state traffic control light and system whereby the number of LED apparatuses are reduced as compared to conventional systems, and whereby the generated light is homogenized.

### SUMMARY OF THE INVENTION

The present invention achieves technical advantages as a solid state light source having a suspended particle particularly useful in traffic and pedestrian control signals to generate homogenous colors of light, and also adapted to generate arrows of different colors.

In one preferred embodiment, the suspended particle is positioned over an array of LEDs, such as a liquid crystal display (LCD) device operating as a light switch to control both the color and shape of the light transmitted therethrough for controlling both pedestrian and automobile traffic. A light diffuser is preferably utilized to homogenize the light from the LED array. The suspended particle includes an electronic filter to pass light of selected colors, such as green, yellow and red. Moreover, the suspended particle can selectively pass light of a selected color over the surface area thereof to generate an arrow of a particular color. Thus, the same light apparatus can generate both solid and arrow light of different colors using one set of LEDs. This achieves technical advantages by reducing the number of light units required in a typical traffic intersection, thus significantly reducing the power consumption and associated cost, reducing the amount of hardware and the associated costs, and providing for a less encumbered intersection by simplifying the traffic light arrangement.

Typically, a separate red light is always provided to accommodate those drivers that are color blind. Thus, one light is always dedicated to generate a red light, while the other light can be versatile to generate different colors and different shapes of signals. Thus, for instance, in one typical implementation only two lights can be provided, one providing red light, and the other providing the different colors of light and arrows.

In yet another embodiment a single pedestrian light control apparatus is provided whereby the suspended particle can generate typical pedestrian signals including the walking pedestrian, the illuminated hand, and even a count down display indicating the time until the pedestrian head changes states. For instance, the count down timer can indicate the number of seconds until the pedestrian head switches from the pedestrian Walk symbol to the Don't Walk hand signal, or, can indicate the number of second until the associated traffic signal turns yellow.

### BRIEF DESCRIPTION OF THE DRAWINGS

FIG. 1 is a front view of an automobile traffic control signal having a first LED light adapted to generate red light, and the lower LED light adapted to generate either solid homogenized colors of green or yellow, or green or yellow arrows;

FIG. 2 depicts the apparatus of FIG. 1 with the lower light generating a left turn arrow capable of being displayed in different colors;

FIGS. 3A, and 3B, depict a pedestrian head having a suspended particle capable of filtering the homogenized LED light to depict a walking pedestrian, a stop hand, a count down timer; or the combination thereof;

FIG. 4 is a front perspective view of one LED apparatus including a suspended particle for generating both solid homogenized light as well as shaped light of different colors according to the present invention;

FIG. 5 is perspective view of the rear of the light of FIG. 4;

FIG. 6 is a side sectional view taken along lines 6-6 in FIG. 4 depicting the LED array, the light diffuser, and the suspended particle disposed over the front lens and modulating the diffused light; and

FIG. 7 is an electrical block diagram illustrating the LED array and suspended particle being controlled by electronics.

### DETAILED DESCRIPTION OF THE PREFERRED EMBODIMENT

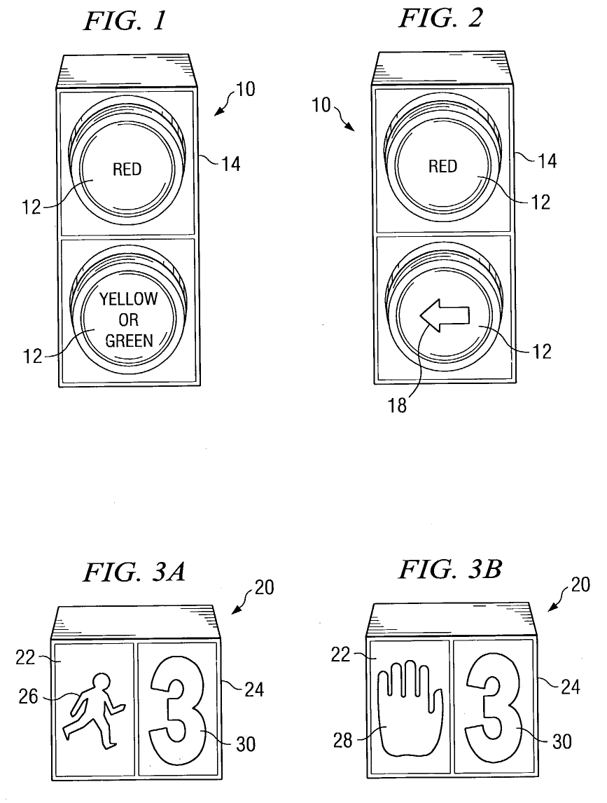

Referring now to FIG. 1, there is depicted generally at 10 a traffic control apparatus having at least two LED light displays generally shown at 12 and mounted within a suitable housing 14. The upper LED light 12 is adapted to generate only red light, while the lower LED light 12 is adapted to generate different colors of lights as well as colored arrows of light, as shown at 18 in FIG. 2. For instance, the lower LED light 12 can generate homogenous light of green or yellow color as well as green or yellow turn arrows, and thus is truly versatile. Two different LED light apparatuses 12 are required to accommodate those drivers who are color blind. As will be discussed shortly, the light beams are generated by a light emitting diode (LED) array. The light beam is homogenized and then filtered by a suspended particle, such as liquid crystal display (LCD) suspended over the lens of the LED light 12. Electronics control the suspended particle to selectively control the shape and color of the light passed according to a control system algorithm for controlling traffic.

Referring to FIG. 3, there is depicted a similar pedestrian head generally shown at 20, whereby the LED light array having the suspended particle is adapted to control pedestrian traffic. In this embodiment, the LCD light 20 is adapted to create a white pedestrian walk symbol shown at 22 in FIG. 3A, an orange hand stop symbol as shown at 24 in FIG. 3B, a count down indicator shown at 26 in FIG. 3C, and either separately or in conjunction therewith a countdown timer as shown in FIG. 3D. Thus, the single pedestrian head 20 can generate any of these three symbols, or others if desired, depending on the state of the pedestrian light, as a function of an associated traffic control signal. As shown in FIG. 3D, the countdown timer 26 may be displayed simultaneously with either the walking symbol 22 or the hand symbol 24 to depict the amount of time, for instance in seconds, until the pedestrian head changes state, i.e., from the walking symbol to the blinking hand symbol, or from the blinking hand symbol to the solid illuminated hand signal associated with a yellow and red traffic light. The apparatus 20 of FIG. 3D is particularly advantageous in that it indicates to pedestrians how much time is left during the blinking hand symbol, until the traffic light begins to change state.

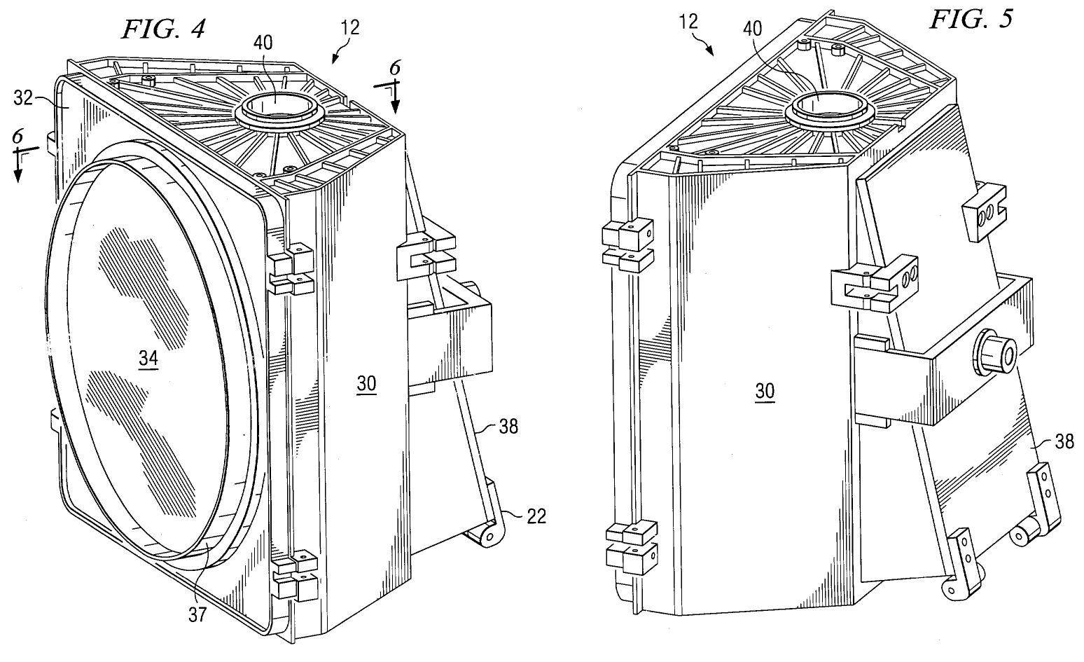

Referring now to FIG. 4, there is depicted one LED light 12 including the suspended particle as previously discussed in regards to the earlier Figures. Light 12 is seen to include a housing 30 having a pivotable front cover 32 holding and securing a clear lens 34. The clear lens 34 is preferably comprised of either glass or plastic, and also provides environmental protection to the underlying suspended particle 36, such as an LCD display as will be discussed shortly with regards to FIG. 5. A light shield 37 is disposed about the lens 34 to shade the light from sunlight. Referring to FIG. 5, the housing 30 is further seen to include a heat conductive rear member 38 comprising a heat sink supporting the array of LEDs mounted thereon and dissipating heat to the ambient. The housing 30 further includes an upper opening 40 and a lower opening 40 (not shown) for facilitating the attachment of one light 12 to another light 12, and to the holding apparatus 14 as shown in FIG. 1. Housing 30 may be formed of metal, but it is preferably comprised of molded plastic to achieve lower cost and lighter weight.

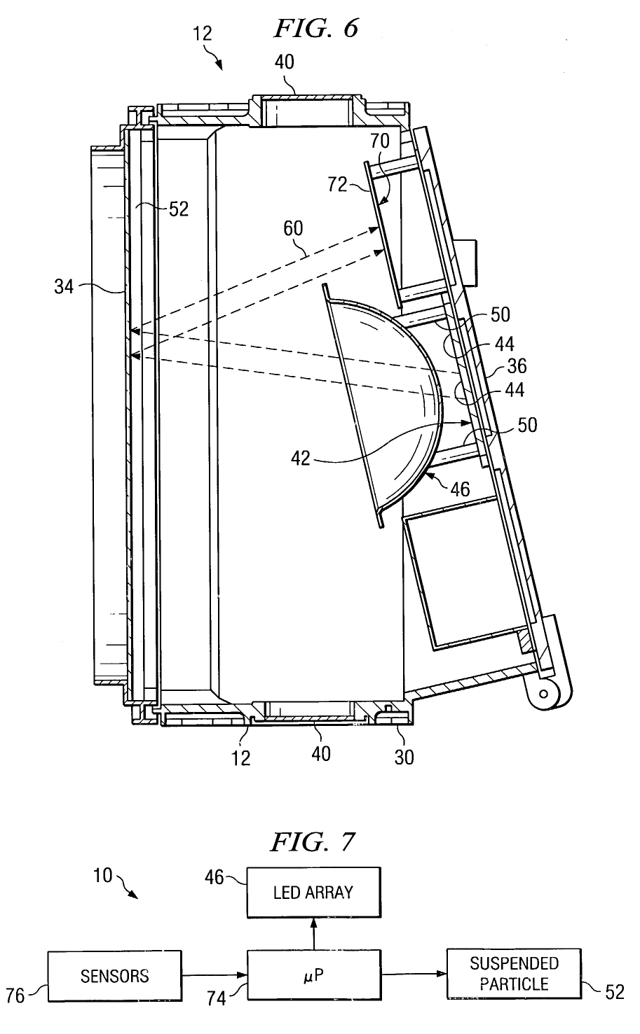

Turning now to FIG. 6, there is illustrated a cross sectional view taken along lines 6-6 in FIG. 4 depicting the light apparatus 12 having an array 42 of LEDs 44 directly mounted upon the heat sink 36. A concave light diffuser shown at 46 is positioned above the LED array 42 by stand offs 50. The diffuser 46 opens upwardly, with a convex surface facing the LED array 42 as shown. This diffuser 46 homogenizes the light from the LED array 42, and directs the homogenized light towards the lens 34 as shown.

Advantageously, a suspended particle 52 operating as a light switch, such as an electrically controllable LCD device, extends across the opening defined by the housing 30 and is protected by the lens 34. The suspended particle 52 operates as an electronic light filter, thus operating as a filter to selectively transmit light therethrough of a desired color, such as green, yellow or red. Since the light is homogenized by the light diffuser 46, the transmitted light is also homogenized of the selected color. Moreover, the directivity of the light generated by the LED array 42 and the lens 34 provides a very focused beam of light.

In addition, the suspended particle 52 is adapted to selectively filter light across the area surface thereof in 2 dimensions, and thus is adapted to pass light of a predetermined shape, such as the arrow shown at 18 in FIG. 2, the pedestrian shown at 22 in FIG. 3A, the stop hand as shown at 24 in FIG. 3B, the numeral as shown at 26 which can count down, or the combination thereof as shown in FIG. 3D.

As shown in FIG. 3D, apparatus 20 is adapted to simultaneously display both a shaped light for controlling pedestrian traffic, such as an orange stop hand 24 which may flash as the count down indicator shown at 26, counts down, such as from 8 seconds to 0 seconds, and which would depict 0 when the hand become continuously illuminated and the associated traffic signal turns yellow and red.

Referring still to FIG. 6, there is shown at 60 that a portion of the light generated from the LED array 42 may backscatter from the suspended particle 52 and the lens 34 to a daughterboard shown at 70 which includes light detection photodiodes 72 to control the intensity of the generated light as a function of the sensed backscattered light.

Referring now to FIG. 7, there is depicted a block diagram of the operating system and electronics for the light 10 and 20 including a microprocessor 74 controlling the LED array 42 to control the light intensity and beam direction generated thereof, as well as controlling the suspended particle 52 to control the light filter passing a selected color of light and defining a shape thereof, and controlling different sensors shown at 76, such as the photodiodes 72 on the daughterboard 70.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A solid state light, comprising;
a solid state light source comprising an area array of light emitting diodes LEDs) generating a light output;
a light diffuser positioned over said LED array diffusing said light output; and
a suspended particle adapted to selectively transmit said light output from said light diffuser to generate a controlled light signal.

2. The solid state light specified in claim 1 wherein said suspended particle controls the shape of said controlled light signal.

3. The solid state light specified in claim 2 wherein said suspended particle also controls the color of said controlled light signal.

4. The solid state light specified in claim 3 wherein said controlled light signal is adapted to control automobile traffic.

5. The solid state light specified in claim 3 wherein said controlled light signal is adapted to control pedestrian traffic.

6. The solid state light specified in claim 4 wherein said suspended particle comprises a variable light filter adapted to separately generate at least green and yellow light as said controlled light signal.

7. The solid state light specified in claim 4 wherein said suspended particle device is adapted to separately generate at least a green arrow and a yellow arrow as said controlled light signal.

8. The solid state light specified in claim 7 wherein said suspended particle device is also adapted to separately generate at least a homogenous green and yellow light as said controlled light signal.

9. The solid state light specified in claim 5 wherein said suspended particle comprises a variable filter adapted to alternately generate the controlled light signal to have the shape of a hand and a pedestrian.

10. The solid state light specified in claim 9 wherein said controlled light signal also includes a count indicator indicative of time.

11. The solid state light specified in claim 10 wherein the count indicator is indicative of how much time is left until the controlled light indicator changes states.

12. The solid state light specified in claim 1 wherein said light diffuser is concave and having a convex outer surface facing said LED array.

13. The solid state light specified in claim 1 wherein said suspended particle device comprises an LCD filter.

14. The solid state light specified in claim 1 wherein said controlled light signal has a sufficient intensity meeting DOT requirements.

15. A method of generating a controllable light beam, comprising the steps of:
a) generating a light output using an area array of light emitting diodes (LEDs); and
b) modulating the light output with a suspended particle to selectively transmit the light output to generate a controlled light signal.

16. The method as specified in claim 15 further comprising the step of using a light diffuser to homogenize the light output from the LED array.

17. The solid state light specified in claim 15 wherein said suspended particle controls the color of said controlled light signal.

18. The solid state light specified in claim 17 wherein said suspended particle also controls the shape of said controlled light signal.

19. The solid state light specified in claim 17 wherein said controlled light signal is adapted to control automobile traffic.

20. The solid state light specified in claim 18 wherein said controlled light signal is adapted to control pedestrian traffic.

21. The solid state light specified in claim 17 wherein said suspended particle comprises a variable light filter adapted to separately generate at least green and yellow light.

22. The solid state light specified in claim 18 wherein said suspended particle device is adapted to separately generate at least a green arrow and a yellow arrow.

23. The solid state light specified in claim 22 wherein said suspended particle device is also adapted to separately generate at least a homogenous green and yellow light.

24. The solid state light specified in claim 20 wherein said suspended particle comprises a variable filter adapted to separately generate the controlled light signal to have the shape of a hand and a pedestrian.

25. The solid state light specified in claim 24 wherein said controlled light signal also includes a count indicator indicative of time.

26. The solid state light specified in claim 25 wherein the count indicator is indicative of how much time is left until the controlled light indicator changes states.

27. The solid state light specified in claim 15 wherein said suspended particle device comprises an LCD filter.

28. The solid state light specified in claim 15 wherein said controlled light has a sufficient intensity meeting DOT requirements.
